(19) United States
(12) Patent Application Publication
(10) Pub. No.: US 2005/0118966 A1
(43) Pub. Date: Jun. 2, 2005

(54) Simple Crest Factor reduction technique for multi-carrier signals

(76) Inventor: Kiomars Anvari, Alamo, CA (US)

Correspondence Address: KIOMARS ANVARI, 1567 SERAFIX RD, ALAMO, CA, 94507, US

(21) Appl. No.: 10/724,491

(22) Filed: Dec. 1, 2003

(51) Int. Cl. H04B 1/04; H01Q 11/12

(52) U.S. Cl. 455/127.2; 455/127.1

(57) ABSTRACT

A technique for Crest Factor reduction of multi-carrier signals is described. The input to the multi-carrier amplifier is modified by a Crest Factor reduction circuit, prior to being applied to the amplifier. The Crest Factor reduction circuit clips the amplitude of the signal, converts the clipped signal to baseband to produce the baseband representative of each carrier, filters each baseband representative to remove the unwanted signals, up converts each baseband representative to its multi-carrier baseband frequency and finally the up converted signals are combined to produce the multi-carrier baseband signal. The input to the Crest Factor reduction circuit could be a baseband, an intermediate frequency (IF) or radio frequency (RF) signal. The Crest Factor reduction could be performed in digital or analog domain.

### BACKGROUND OF INVENTION

The present invention relates to a Crest Factor reduction circuit to boost the out put power of a multi-carrier wireless RF amplifier. The Crest Factor reduction circuit input could be baseband, intermediate frequency (IF), or RF signal and its output is the Crest Factor reduced RF signal as a new input to the amplifier. In any wireless communication system one of the critical components is the power amplifier. This component has a major contribution in cost, power consumption, and size of the system. The main reason is the requirement of wireless radio communication system for linear amplifiers. The higher the linearity, the higher the power consumption, cost and size. In order to minimize the cost, size and power consumption there is a need for techniques that overcome this problem. This invention conquers these challenges by using a simple and accurate Crest Factor reduction module used at the input to the amplifier.

### SUMMARY OF INVENTION

According to the invention, a low-cost RF Crest Factor reduction circuit, for use with multi-carrier RF amplifier, uses a plurality of simple and accurate circuits in conjunction with intelligent signal processing to improve power handling of the multi-carrier RF amplifier. By intelligent, it is meant that the Crest Factor reduction module has features of removing the unwanted signals after applying the crest factor reduction function. The Crest Factor reduction module uses the amplifier input which could be a baseband, an IF or RF signal as its input and conditions the input before applying to the multi-carrier amplifier. The conditioning or Crest Factor reduction helps to boost the power handling of the amplifier or acts more linearly. The inputs to the Crest Factor reduction should be within a limit that can be handled by the Crest Factor reduction module.

In a particular embodiment, the Crest Factor reduction unit comprises a multi-carrier transmitter and a multi-carrier broadband receiver, a signal processing, and a clock generator. The receiver and transmitter convert the baseband, IF, or RF signal to digital baseband and the digital baseband signal to RF. The signal processor performs the signal conditioning as well as performs the initial calibration, and transmitter and receiver control.

The invention will be better understood by reference to the following detailed description in conjunction with the accompanying drawings.

### BRIEF DESCRIPTION OF THE DRAWINGS

FIG. 1 is an overall block diagram of the a amplifier with a booster using Crest Factor reduction

FIG. 2 is the block diagram of the Crest Factor reduction module

FIG. 3 is the block diagram of the digital processing unit of Crest Factor reduction module

FIG. 4 is the block diagram of the digital signal processing block performing the Crest Factor reduction

FIG. 5 is the detail block diagram of Crest Factor reduction

### DESCRIPTION OF THE SPECIFIC EMBODIMENTS

In a first preferred embodiment the Crest Factor reduction circuit monitors the signal strength of the multi-carrier input signal channels using the input receiver and finds the frequency and channel number of the input signals. In a second preferred embodiment of the invention, the Crest Factor reduction circuit uses sub-harmonic sampling to convert multi-carrier RF or IF signals to digital baseband signal. In a third preferred embodiment the input signal is conditioned or Crest Factor reduced using the multi-carrier baseband signal. In a fourth embodiment the digital baseband signal is further down converted to produce the individual carrier baseband signal. In a fifth embodiment the multi-carrier signal is amplitude clipped or limited either in analog or digital domain. In a sixth embodiment the individual baseband signals are individually filtered and up converted to reconstruct the multi-carrier digital baseband signal.

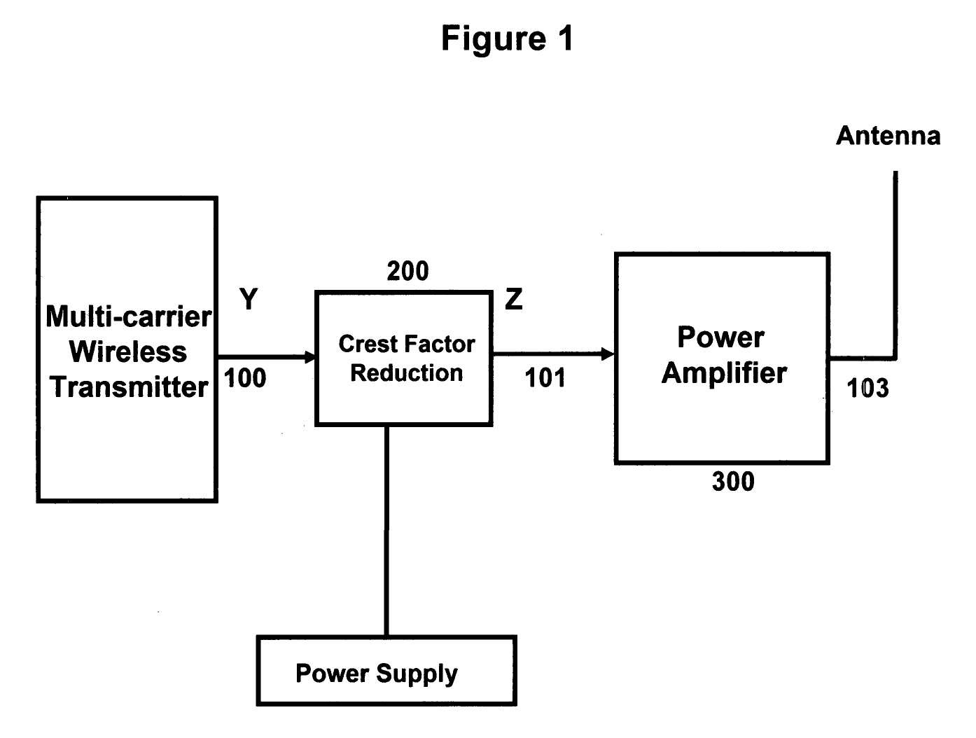

Referring to FIG. 1, a Crest Factor reduction circuit diagram is illustrated. The systems receive its inputs from wireless transmitter 100. The output of the Crest Factor reduction circuit 200 is applied to the input of the amplifier. The Crest Factor reduction circuit performs the following functions:
1. Finds the frequencies and channel numbers of the multi-carrier wireless transmitter output 100.
2. Reduce the Crest Factor of the input signal 100 before applying to amplifier.
3. Adaptively adjust the gain in the signal paths to keep the total gain from input to output of the Crest Factor reduction zero.

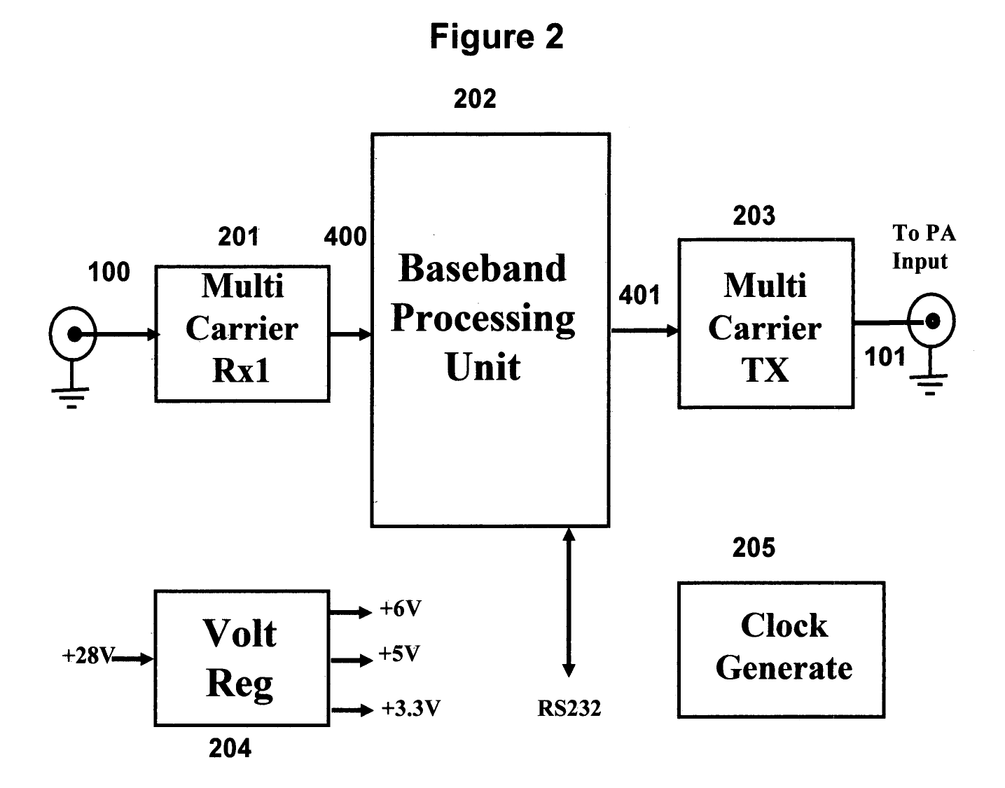

FIG. 2 illustrates the detail block diagram of the Crest Factor reduction circuit unit. The received signal from multi-carrier wireless transmitter 100 is applied to multi-carrier receiver 201 to produce signal 400. The output of the multi-carrier receiver 201 is applied to signal processing block 202 for digital signal processing which is Crest Factor reduction and filtering of baseband representation of each carrier. The output of signal processing block 202 the Crest Factor reduced signal 401 is applied to multi-carrier transmitter 203 to create the input signal 101 for the multi-carrier amplifier. Clock generator 205 produces all the clocks necessary for the Crest Factor reduction circuit and the power supply block 204 produce all the voltages necessary for the Crest Factor reduction circuit.

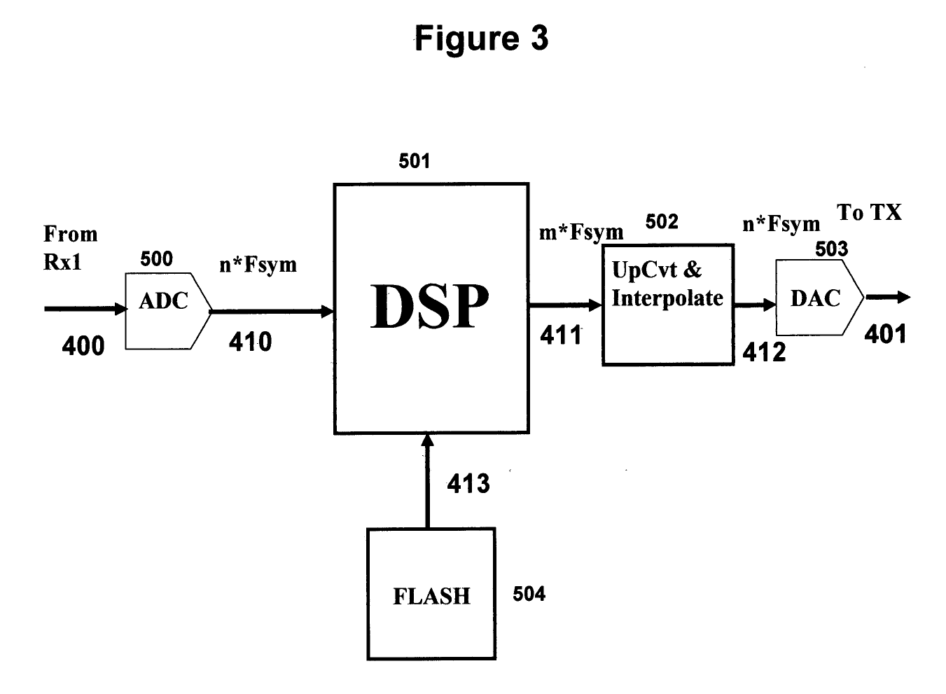

FIG. 3 shows the detail block diagram of the Crest Factor reduction signal processing block 202. The receiver block 201 output 400 is applied to analog to digital converter (in case the signal is RF, IF, or baseband ) block 500 to produce the digital signal 410. If the signal is RF or IF the analog to digital conversion is based on sub-harmonic sampling. The output of the analog to digital converter 500 is applied to the DSP block 501 for down conversion and decimation to produce “m” sample per symbol. In case the signal is a multi-carrier baseband the signal may need to be interpolated or decimated to produce the right number of samples per symbol. If the signal is baseband but in bit format the up conversion function of 501 is used. The signal is converted to symbol domain with desired samples per symbol first and then each channel is up converted to its baseband frequency to produce multi-carrier baseband. The DSP block 501 also performs the Crest Factor reduction and produce signal 411. The Crest Factor reduced signal 411 is applied to up converter and interpolator 503 to produce the up converted and interpolated signal 412. Signal 412 is applied to digital to analog converter 503 to produce the analog signal 401 for the multi-carrier transmitter block 203.

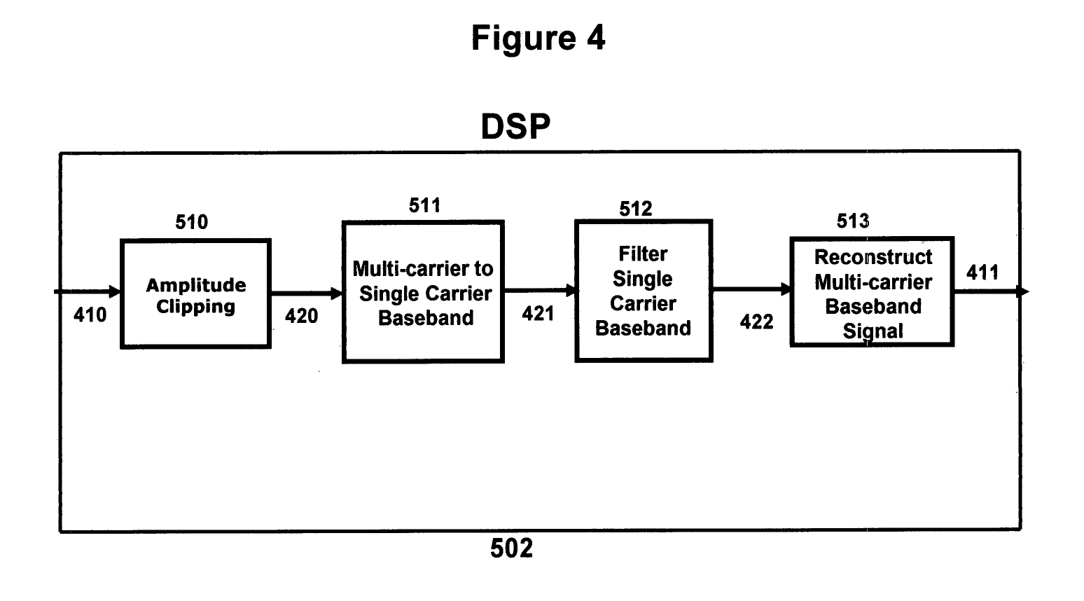

FIG. 4 shows the block diagram of the Crest Factor reduction block 502. The multi-carrier baseband signal 410 from the main multi-carrier receiver has its amplitude clipped by amplitude clipping block 510 to produced amplitude limited multi-carrier signal 420. The amplitude limited signal 420 is down converted to single carrier baseband signals by block 511 to produce the baseband representative of each individual carrier. The individual single carrier baseband signals 421 are filtered by filter block 512 to produce the filtered signals 422. The filtered signals 422 are applied to block 513 to reconstruct the multi-carrier baseband signal 411.

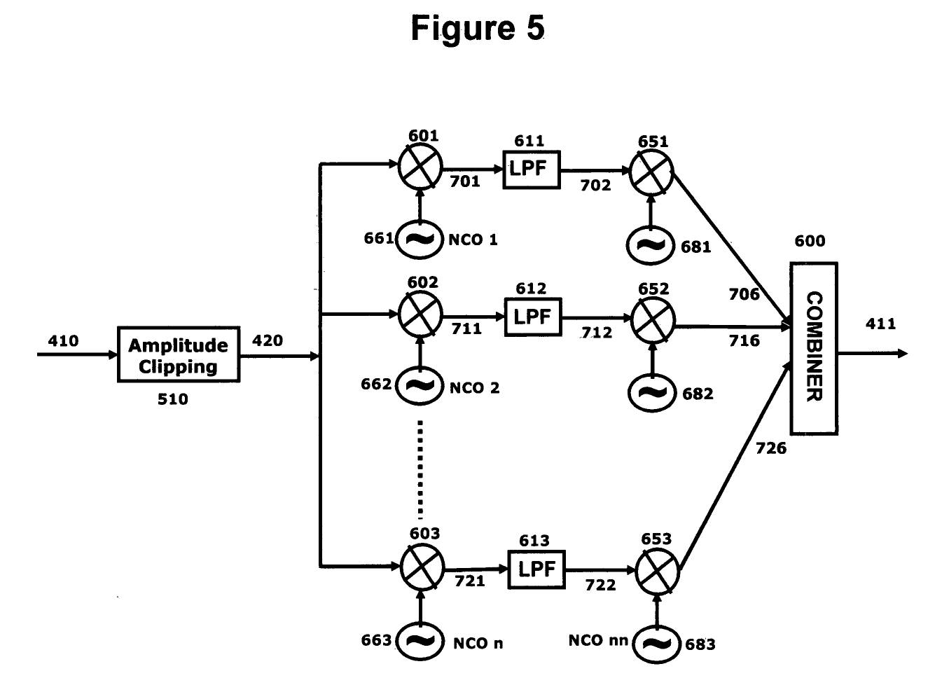

FIG. 5 shows the detail block diagram of the Crest Factor reduction circuit. The multi-carrier baseband signal 410 from the receiver is applied to amplitude clipping block 510 to produce amplitude limited multi-carrier signal 420. The amplitude limited signal 420 is applied to down converters 601, 602, and 603 to produce the baseband signal of each carrier 701, 711, and 721. The second input to down converters 601, 602, and 603 are supplied by NCOs 661, 662, and 663. The baseband representative of each carrier then is applied to Low Pass Filters (LPF) 611, 612, and 613 to filter unwanted signals. The filtered baseband representative of each carrier 702, 712, and 722 is applied to up converter blocks 651, 652, and 653. The other signal used by up converter is supplied by NCOs 681, 682, and 683. The up converted signals 706, 716, and 726 are then combined in block 600 to produced the new multi-carrier baseband signal 411. In FIG. 5 only a multi-carrier with 3 carrier is shown. This approach can be applied to unlimited number of carriers.

1. A wireless Crest Factor reduction circuit for use with multi-carrier signals in a wireless communication system to enhance the linearity and performance of the amplifier, in particular wireless cellular, PCS, wireless LAN, line of sight microwave, military, and satellite communication systems and any other none wireless applications, the Crest Factor reduction circuit comprising:
A multi-carrier receiver for the Crest Factor reduction of IF or RF input signal to amplifier. If the input signal is baseband then the multi-carrier receiver is bypassed.
A digital signal processing block to reduce the Crest Factor of the multi-carrier input signal.
A digital signal processing block to limit or clip the amplitude of the multi-carrier signal.
A digital signal processing block that converts the amplitude clipped or limited multi-carrier baseband to baseband representative of individual carrier signals.
A digital signal processing block that filters the baseband representative of individual carrier baseband signal to remove unwanted signal produced due to clipping or limiting the multi-carrier signal amplitude.
A digital signal processing signal that up converts the filtered baseband representative of each carrier to its original baseband frequency.
A multi-carrier transmitter block that prepare the Crest Factor reduced multi-carrier signal for delivery to multi-carrier amplifier.

2. The Crest Factor reduction circuit according to claim 1, wherein multi-carrier input signal from the wireless transmitter is sampled using sub-harmonic sampling technique at the input frequency or at an intermediate frequency.

3. The Crest Factor reduction circuit according to claim 1, wherein the multi-carrier input signal from the wireless transmitter is sampled using sub-harmonic sampling technique at the input frequency or at an intermediate frequency and the digitized multi-carrier input signal is decimated to the appropriate number of samples per symbol for further digital signal processing.

4. The Crest Factor reduction circuit according to claim 1, wherein the multi-carrier input signal from the wireless transmitter is baseband and is sampled using Nyquist sampling technique and interpolated to produce the baseband multi-carrier signal with appropriate number of samples per symbol.

5. The Crest Factor reduction circuit according to claim 1, wherein the multi-carrier input signals from the wireless transmitter are in bit domain and the bit domain baseband signals are up converted, combined and interpolated to produce the digital multi-carrier baseband signal with appropriate number of sample per symbol.

6. The Crest Factor reduction according to claim 1, wherein the digital multi-carrier signal is amplitude clipped or limited by a limiting or clipping function. The amplitude limited multi-carrier signal is then down converted to single channel baseband signals by digital down conversion. The individual baseband signals are filtered and up converted back to their original baseband frequency before all individual baseband signals being combined again to produce the multi-carrier Crest Factor reduced baseband signal.

7. The Crest Factor reduction according to claim 1, wherein the multi-carrier signal amplitude clipping or limiting can be perform in analog domain at an intermediate frequency (IF), radio frequency, or analog baseband before being digitized.

8. The Crest Factor reduction according to claim 1, wherein the amplitude limited digital multi-carrier baseband signal is converted to single channel baseband signals by digital down conversion.

9. The Crest Factor reduction circuit according to claim 1, wherein the Crest Factor reduced signal is digitally up converted and converted to analog domain at an intermediate frequency or the output frequency.

10. The Crest Factor reduction circuit according to claim 1, wherein the received signal strength of the input signal to Crest Factor reduction circuit and transmit signal strength of the output from the Crest Factor reduction circuit is dynamically measures to adjust the total gain of the Crest Factor reduction circuit to zero

11. The Crest Factor reduction circuit according to claim 1 and subsequent claims, when it is used in wireless cellular, wireless PCS, wireless LAN, microwave, wireless satellite, none wireless amplifiers, and any wireless communication systems used for military applications.

12. The Crest Factor reduction circuit according to claim 1, wherein the DSP function can be implemented in programmable logic, FPGA, Gate Array, ASIC, and DSP processor
